(19) United States
(12) Patent Application Publication
(10) Pub. No.: US 2006/0058897 A1
(43) Pub. Date: Mar. 16, 2006

(54) On-vehicle power supplying apparatus with two power supplies

(75) Inventors: Takashi Senda, Niwa-gun (JP); Akira Kato, Kani-shi (JP); Katsunori Tanaka, Haguri-gun (JP); Takeshi Shimoyama, Kariya-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/209,816

(22) Filed: Aug. 24, 2005

(30) Foreign Application Priority Data
Aug. 24, 2004 (JP) 2004-244063

(51) Int. Cl. G05B 11/01; G05D 11/00; G05D 17/00; G05D 3/12; G05D 5/00; G05D 9/00

(52) U.S. Cl. 700/22; 700/286; 700/295

(57) ABSTRACT

An on-vehicle power supplying apparatus comprises a first battery charged by a generator driven by an on-vehicle engine, a second battery connected to an on-vehicle electric load, and a power adjuster adjusting power to be supplied from both of the first and second batteries to the electric load. For adjusting the power, he power adjuster uses a predetermined order in which the first battery is firstly made to supply the power to the electric load, provided that a residual capacity of the first battery is higher than a predetermined threshold, before making both the first and second batteries supply the power to the electric load cooperatively.

### CROSS REFERENCE TO RELATED APPLICATION

The present application relates to and incorporates by reference Japanese Patent application No. 2004-244063 filed on Aug. 24, 2004.

### BACKGROUND OF THE INVENTION

1. Field of the Invention

The present invention relates to an on-vehicle power supplying apparatus with two (dual) power supplies, and in particular, to a dual power-supply type of on-vehicle power supplying apparatus with a plurality of batteries.

2. Description of the Related Art

In recent years, vehicles that are able to stop their idling operations at intersections or other necessary places have been increased for not only saving fuel consumption but also environmental issues. Such vehicles are called “idling-stop vehicles.” A hybrid car (i.e., gas-and-electric car) is one type of the idling-stop vehicles.

In the idling-stop vehicles, one or more batteries alone are obliged to supply power to electric loads during an engine stop. Though there is such a circumstance, it is preferred that an electric compressor for an air conditioner is included in electric loads to be mounted on a vehicle.

A dual power-supply type of on-vehicle power supplying apparatus, which employ a plurality of batteries, have been known as well. This type of on-vehicle power supplying apparatus is categorized into two types, which are an equi-voltage dual power-supply type and an unequi-voltage dual power-supply type.

One example of the unequi-voltage two supply type is proposed by Japanese Patent Laid-open publication No. 2002-345161. In a power supplying apparatus according to this publication, there is provided a generator which operates as a starter motor. During an ordinal operation of the apparatus, the generator charges a first battery of a higher terminal voltage and supplies power to both a second battery of a lower terminal voltage and electric loads powered by the second battery, via a power transmission unit. If an idling-stop vehicle employs this unequi-voltage two supply type of power supplying apparatus, it is possible to prevent power voltage to the electric loads from lowering in response to starting the engine, because those electric loads can be driven on the power from the second battery that is not in charge of starting the engine.

In addition, this unequi-voltage dual power-supply type of power supplying apparatus is configured to cope with idling-stop vehicles that start their engines frequently. Every time when such vehicles start their engines, a current flowing along a path connected from the first battery to the second battery is lowered to reduce resistance loss. It is therefore possible to make wirings for power transmission compact and less weight. In this unequi-voltage dual power-supply type of power supplying apparatus, a proposal is also made such that, if the power transmission unit is formed into a bilateral transmission type, the power transmission unit is driven to inversely transmit the power from the second battery to the first battery when the engine is started in a condition where the residual power amount stored in the first battery is below a predetermined level.

On the other hand, as teachings for the foregoing equi-voltage dual power-supply type of power supplying apparatus, further Japanese Patent Laid-open publications No. 5-278536 and No. 7-322531 have been known. These publications exemplify apparatuses based on the equi-voltage dual power-supply type, which cope with a decrease in the voltage which is to be caused in re-starting after stopping an idling operation. To prevent such a decrease in the voltage from being influenced on predetermined on-vehicle electric loads other than a starter motor, the following configurations are exemplified in those apparatuses. The configurations include a first battery supplying engine-starting power to the starter motor, which usually functions as a generator as well, and a second battery powering particular electric loads, such as lighting devices, a radio, and control devices, which dislike decreases in the voltage. Both of the first and second batteries, which are different from each other, are mutually connected via a relay. When starting the engine, the relay is made open, so that a decrease in the voltage to the particular electric loads can be avoided.

Though this equi-voltage two supply type of power supplying apparatus is able to avoid the voltage decreases to the electric loads in starting the engine, described above, the advantages obtained by the non-equi-voltage two supply type cannot be attained.

However, in the case of the non-equi-voltage dual power-supply type with the power transmission unit is applied to idling-stop vehicles, there is a drawback. Specifically, electric loads are driven by the second battery during an idling-stop operation, resulting in that the longer a period of idling-stop time, the less the residual power capacity of the second battery. The engine starts after stopping the idling-stop operation thus gives rise to a decrease in improvement of fuel consumption which is due to the idling stop. One countermeasure against this drawback is to make the capacity of the second battery larger, which will conversely invite increases in the size, weight and manufacturing cost of the second battery.

### SUMMARY OF THE INVENTION

The present invention has been completed with the above view in mind and has an object to provide the on-vehicle power supplying apparatus operating on the two power supply devices, which is able to prevent a swell in the sizes of batteries and prolong the idling-stop time.

To achieve the above object, as one mode, the present invention provides an on-vehicle power supplying apparatus comprising: a first power-supply system having a generator driven by an on-vehicle engine and a first battery charged by the generator; a second power-supply system having a second batty connected to an on-vehicle electric load; a power transmission unit transmitting power from the first power-supply system to the second power-supply system; and a controller controlling an operation of the power transmission unit to adjust, when the engine is stopped, the power transmitted from the first power-supply system to the second power-supply system in a predetermined order in which the first battery is firstly made to transmit the power to the electric load, provided that a residual capacity of the first battery is higher than a predetermined threshold.

Preferably, the controller comprises first means for calculating the residual capacity of the first battery when the engine is stopped, second means for determining whether or not the residual capacity of the first batter is higher than the predetermined threshold, and third means for controlling the operation of the power transmission unit to firstly make the first battery supply the power to the electric load in response to a stop of the engine, when it is determined that the residual capacity of the first battery is higher than the predetermined threshold, and then to make the second battery supply the power to the electric load, together with the supply of the power by the first battery.

It is therefore possible to lessen the burden of the second battery in its charge and discharge operations and to make the second battery compact with its capacity kept smaller. In particular, in a short period of time in which the engine is stopped, the power to be supplied to the electric load can be covered by the discharge from only the first battery.

Further, in cases where the first battery is ordered to preferentially discharge toward the electric load during a stop of the engine, a drop in the voltage of the second power-supply system can be avoided suitably.

Hence a drop in the power to be supplied to the electric load can be suppressed as well, lessening drawbacks caused by the voltage drop. Incidentally, the “preferential discharge” should be understood to include the “discharge of the first battery alone” to the electric load,

Furthermore, compared to allowing only the second battery to supply the power to the electric load during a stop of the engine, the supply of the power to the electric load during an idling-stop operation can be kept longer in time. Accordingly, without making the second battery larger in its size, a period of time for the idling stop can be made longer.

Meanwhile, despite of the preferential discharge of the first battery, the preferential discharge to the electric load is stopped in response to a situation where the residual capacity of the first battery is lowered than a preset value. Thus, as to the fact that the first battery is relieved from supplying the power to the electric load, the first battery can be prevented from lowering in its capacity and from being discharged excessively.

As another mode, the present invention provides an on-vehicle power supplying apparatus comprising a first power-supply system having a generator driven by an on-vehicle engine and a first battery charged by the generator; a second power-supply system having a second battery connected to an on-vehicle electric load; a power transmission unit transmitting power from the first power-supply system to the second power-supply system; and a controller controlling an operation of the power transmission unit to adjust, when the engine is stopped, so that both of the first and second batteries supply the power to the electric load cooperatively.

This cooperative power supply to the same electric load (for example, a drive motor for air conditioning compressor) during an idling-stop operation, the burden shares of the first and second batteries in supplying the power are reduced respectively. Hence the fuel consumption can be improved, because battery loss in the discharge operations can be reduced, and the life time of the battery can be made longer.

### BRIEF DESCRIPTION OF THE DRAWINGS

In the accompanying drawings:

FIG. 1 is an electrical block diagram showing a dual power-supply type of on-vehicle power supplying apparatus according to a first embodiment of the present invention;

FIG. 2 is a flowchart explaining the control operations performed by a controller in the apparatus;

FIG. 3 is a view explaining changes of a threshold for switching start depending on amounts of electric loads, which is used by a modification of the first embodiment;

FIG. 4 is a timing chart showing changes in a state value used in the modification shown in FIG. 3; and

FIG. 5 is a partial flowchart explaining the operations in the modification.

### DETAILED DESCRIPTION OF PREFERRED EMBODIMENTS

An embodiment of an on-vehicle power supplying apparatus according to the present invention will now be described below in detail is with reference to the accompanying drawings.

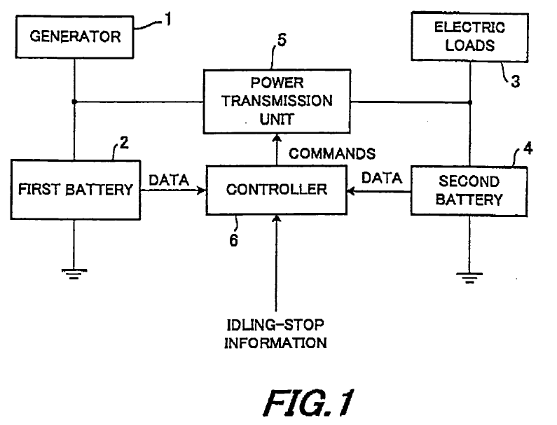

FIG. 1 is a block diagram showing the overall electrical configuration of an on-vehicle power supplying apparatus according to the present embodiment. As shown, this apparatus is provided with a generator 1, a first battery 2, electric loads 3, a second battery 4, a power transmission unit 5, and a controller 6.

Of these, the generator 1, which is driven by an on-vehicle engine, is formed as a known AC (alternating current) generator with rectifiers integrated therein. Alternatively, this generator 1 may be a synchronous motor generator (MG) which operates using a starter motor or a torque assist manner. In the case of the torque assist manner, the first battery 1 is controlled to discharge to the motor generator for the torque assist operation.

The first battery 2 is electrically connected to output terminals of the generator 1 via only cables to transmit and receive power therebetween. Both the generator 1 and the first battery 2 form a first power-supply system PS1.

The first battery 2 is able to store therein surplus power which is generated by the generator 1 but temporarily surplus. During a stop of the engine, it is required for the first battery 1 to store power which is part or all of an amount of power needed to re-start the engine.

Furthermore, the first battery 2 is able to store power generated by regenerative braking performed by the generator 1 when the vehicle is in braking. The stored regenerative power can be discharged to the electric loads 3.

The electric lords 3 are mounted on the vehicle and electrically connected to the second battery 4 via cables so that they are powered by the second battery 4. In this embodiment, the electric lords 3 include a starter motor and another motor to drive a compressor for an on-vehicle air conditioner. A modification to this configuration is to arrange this starter motor in the first power-supply system. The second battery 3 forms a second power-supply system PS2 electrically connected to the electric loads 3.

In the case that power consumption by the eclectic loads 3 rises temporarily, the first battery 1 has the function of supplying power to the electric loads 3. Such rises includes a rise occurring in a case where the engine is started by driving a starter motor, which is one of the electric loads 3 of the second power-supply system PS2.

The first power-supply system PS1 is higher in voltage (that is, the terminal voltages of both the first and second batteries 2 and 4) than the second power-supply system PS2. Accordingly, the first power-supply system PS1 can be made more compact and less weight and can be reduced with regard to its resistive loss.

In the present embodiment, it is preferred that the first battery 2 has charge and discharge characteristics which are excellent than those of the second battery 4. The first battery 2 is a lithium secondary battery of four-cell serially connected type, which is good in its rapid charge and discharge characteristics. But, the first battery 2 will not be limited to this type and other types of batteries can be used as this battery 2.

The voltage of the second power-supply system PS2 is set to a value equal to an ordinary power supply voltage for vehicles, whereby the electric loads 3 can be prevented from being changed in their electric specifications. In the present embodiment, the second battery 4 is a 12-volts lead secondary battery, which can be commercially available at lower cost. The second battery 4 will not be limited to this one and other types of batteries can be used as this battery 4.

Because the cell voltages of both the first and second batteries 2 and 4 are different from each other in the present embodiment, the terminal voltages of the respective first and second batteries 2 and 4 (in other words, the voltages of both the power supply systems PS1 and PS2) are also different from each other, unless any particular countermeasures are taken. Thus, to reduce a difference between the voltages, the number of serial cells disposed in each battery can be adjusted.

The power transmission unit 5 is arranged to electrically connect both the first and second power-supply systems PS1 and PS2. By way of example, the present embodiment employs the power transmission unit 5 as a unit to transmit power in the only direction from the first power-supply system PS1 to the second power-supply system PS2. This power transmission unit 5 can be formed by using various types of circuits including e DC-DC converter, a series regulator, and a relay-resistor circuit involving a serial connection of a resistor and a relay.

Especially, when the generator 1 is formed by a generator motor which can be started by an on-vehicle engine, the DC-DC converter, which allows the power to be transmitted in the bi-directions, can be used as the power transmission unit 5.

Furthermore, the controller 6 is arranged to control the power transmission unit 5 on the basis of bits of information indicative of working conditions of the first and second batteries 2 and 4, so that the transmission of power from the first power-supply system PS1 to the second power-supply system PS2 can be controlled. The power transmission unit 5 is thus composed of a circuit to transmit the power in response to instructions from the controller 6.

In the present embodiment, both the controller 6 and the power transmission unit 5 function as a power adjuster adjusting the power to be supplied from both the first and second batteries to the electric loads 3.

The controller 6 is a sole unit dedicated to controlling the power transmission, but may be an on-vehicle electric controller which has been known as an ECU (electric control unit) mounted on a vehicle. That is, the ECU may be designed to work as the controller 6 as well

The controller 6 is in charge of carrying out two types of control operations. One type of control operation is carried out when the generator 1 is in operation, while the other type is carried out when the generator 1 is stopped.

In the case that the generator 1 to be driven by the on-vehicle engine is in operation (i.e. the ordinal operation), the controller 6 controls the generator 1 or the power transmission unit 5 in a feed-back manner in order to adjust the terminal voltage (i.e. capacity) of the second battery 4 to a given target level. In this ordinal operation, the output voltage of the generator 1 is adjusted within a predetermined range that prohibits the capacity of the first battery 2 from deviating from its allowed use region (for example, SOC20-60%). For that this control itself has been known, the detailed explanation of this control will be omitted here.

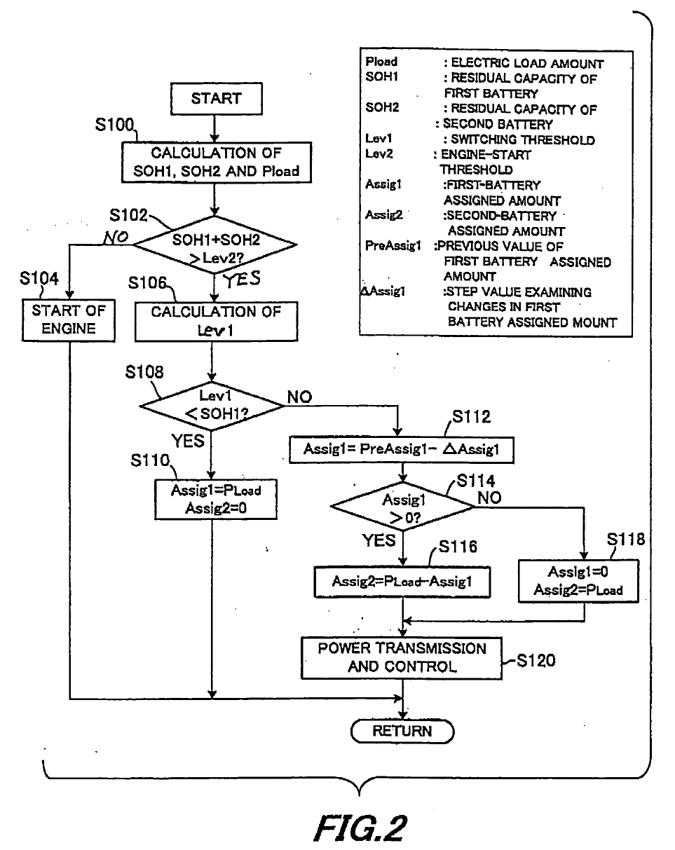

In connection with FIG. 2, the operations of the power transmission unit 5 performed by the controller 6 during a stop of the engine will now be detailed. In this control, the concept according to the present invention is reduced to practice.

This control, that is, the control to be performed during an engine stop, is activated every time when the controller 6 receives an input of idling-stop information (i.e., information indicating stopping an idling operation).

First, in the controller 6, a residual capacity SOH1 of power of the first battery 2, a residual capacity of SOH2 of power of the second battery 4, and an amount of electric load Pload that is power consumed by the electric loads 3 are calculated (step S100). How to calculate these amounts has already been known well, so the explanations will be omitted here. In the present embodiment, the unit of the residual capacities SOH1 and SOH2 is AH (ampere hour), whilst that of the electric load amount Pload is WH (watt hour).

In the controller 6, a sum of the residual capacities SOH1 and SOH2 of both the batteries 2 and 4 is calculated (SOH1+SOH2) and it is determined whether or not the sum is over a predetermined engine-start threshold Lev2 (step S102). That is, the calculation and determination of SOH1+SOH2>Lev2 is performed. This threshold Lev2 is assigned to a level for measuring a total residual capacity necessary for starting the engine.

In this calculation and determination, there is no problem if the residual capacities SOH1 and SOH2 are given as the unit of WH. However, the voltage is different in level between the first and second power-supply systems PS1 and PS2. Thus, when the unit of the residual capacities SOH1 and SOH2 is given as AH, the sum of the residual capacities SOH1 and SOH2 is calculated based on the voltage (reference) of the first power-supply system PS1 in order to compensate for the difference in the voltage levels. Owing to the fact that an efficiency η of power transmission of the power transmission 5 is less than 1, it is preferred that the residual capacity SOH2 of the second battery 4 is multiplied by the efficiency η before the residual capacity SOH2 is added to the residual capacity SOH1 of the first battery 2. In short, it is preferred that, at step S102, the residual capacity sum “SOH1+SOH2” thus calculated based on the voltage level in the first power-supply system PS1 is made compared to the predetermined engine-start threshold Lev2.

In addition, another preferred example is that this engine-start threshold Lev2 is set to an amount figured out by multiplying a minimum amount of power necessary for starting the engine by a predetermined margin factor. The threshold Lev2 is calculated based on the unit of AH, which is a reference determined by the voltage of the first power-supply system PS1. Errors resultant from fluctuations in the voltage of the first power-supply system PS1 which are caused when the engine is started can therefore be absorbed by the margin factor to be multiplied.

When the determination at step 102 reveals that the residual capacity sum “SOH1+SOH2” is equal to or less than this engine-start threshold Lev2, the controller 6 issues commands to terminate an idling-stop operation and to re-start the engine (step S104), before completing this routine.

In contrast, when the opposite determination to the foregoing comes out, that is, it is determined that the residual capacity sum “SOH1+SOH2” is over than this engine-start threshold Lev2, the controller 6 is able to recognize that the batteries are possible to keep providing power to the electric loads 3 even during this idling operation. Hence the controller 6 calculates a threshold Lev1 for starting switches (hereinafter referred to as a switching threshold Lev1) (step S106). This switching is threshold Lev1 expresses a level to determine if or not the residual capacity SOH1 of the first battery 2 is able to solely power the electric loads 3 (the unit thereof is AH).

It is then determined whether or not the residual capacity SOH1 of the first battery 2 is larger than the switching threshold Lev1 (step S108). If it is determined YES at step 108, that is, it is found that the first battery 2 has the residual capacity of power which is sufficient to drive the electric loads 3 by itself, amounts of power Assig1 and Assig2 assigned to the first and second batteries 2 and 4 respectively will be determined as follows (step S110). Namely, a first-battery assigned amount Assig1 (its unit is W) to be assigned to the fist battery 2 is made equal to the electric load amount Pload that has been calculated (its unit is W), while a second-battery assigned amount Assig2 (its unit is W) to be assigned to the second battery 4 is adjusted to zero (step S110).

As a modification, the first-battery assigned amount Assig1, the second-battery assigned amount Assig2, and the electric load amount Pload may be calculated based on the unit of current (amperes) figured out from the voltage (to be considered as a reference) of the second power-supply systems.

However, when it is determined at step S108 that the first battery 2 is solely difficult to drive the electric loads 3 because there is no sufficient power left in the first battery 2, the power adjustment is such that the first-battery assigned amount Assig1 is set to an amount calculated by subtracting a predetermined change amount ΔAssig1 from the previous first-battery assigned amount Assig1 which is expressed as PreAssig1 (step S112). In assigning the power amounts to be supplied respectively from the first and second batteries 2 and 4, the predetermined change amount ΔAssig1 is a step amount to examine how large the first-battery assigned amount Assig1 is.

Incidentally the first processing of the routine shown in FIG. 2 is performed under the conditions of the previous first-battery assigned amount PreAssig1 is set to the electric load amount Pload (i.e., the is first-battery assigned amount Assig1=the electric load amount Pload).

The unit of the amounts to be processed in this adjustment can be modified further. In other words, the unit of the amounts PreAssig1 and ΔAssig1 has been set to WH in the present embodiment. However, in cases where the first and second-battery assigned amounts Assig1 and Assig2 and the electric load amount Pload are calculated as the unit of current (A) obtained from the voltage (i.e., reference) of the second power-supply system PS2, which is an easier manner, a preferred way is to adjust the unit of both the amounts PreAssig1 and ΔAssig1 to that of the amounts Assig1 and Assig2. That is, it is preferred to use the unit of current (A) based on the voltage of the second power-supply system PS2, the voltage serving as a reference.

The controller 6 then shits the processing to a determination at step S114, at which it is determined whether or not the first-battery assigned amount Assig1 is higher than zero. If this condition is found to be true (YES at step S114); that is, Assig1>0, a reduction is made from the electric load amount Pload by an amount of the first-battery assigned amount Assig1 to figure out a value of the second-battery assigned amount Assig2 (step S116).

The unit of the second-battery assigned amount Assig2 is WH as well, which is the same as the first-battery assigned amount Assig1. Hence, as an easier manner, it is preferred to give the unit of current (AH) to the second-battery assigned amount Assig2, if both the first-battery assigned amount Assig1 and the electric load amount Pload are processed based on the unit of current (AH) calculated using, as a reference, the voltage of the second power-supply system PS2.

In contrast, when it is determined at step S114 that the first-battery assigned amount Assig1 is equal to or less than zero, the processing is shifted to step S118, where the first-battery assigned amount Assig1 is set to zero and the second-battery assigned amount Assig2 is set to be equal to the electric load amount Pload.

In the controller 6, the processing at step S120 follows either the process at step S116 or S118. That is, both the first and second-battery assigned amounts Assig1 and Assig2, which are updated in real time through the foregoing routine, are used to control the operations at the power transmission unit 5 by giving corresponding instructions to the power transmission unit 5 (step S120). On completion of issuing the instructions to the unit 5, the controller 6 returns the processing to a not-shown main processing flow which supervises this routine shown in FIG. 2. Under the control of the main processing flow, the routine shown in FIG. 2 is repeated at intervals as timer interruptions. Whenever the controller 6 receives a signal indicating the end of this idling stop from the on-vehicle ECU, the processing of the routine shown in FIG. 2 is stopped from being repeated.

Of the processing described above, the control of the power transmission at step S120, that is, the control of the power transmission unit 5 based on the first and second-battery assigned amounts Assig1 and Assig2 will now be detailed more.

When this power transmission control enables the power (WH) corresponding to the first-battery assigned amount Assig1 to be transmitted from the first battery 2 to the second power-supply system PS2 via the power transmission unit 5, this power to be transmitted is fed to the electric loads 3. Hence, in this case, a residual of power which is still wanted for the electric load amount (WH) required by the electric loads 3 should be supplied automatically by the second battery 4.

The power transmission unit 5 whose power transmission efficiency is η is able to transmit the power corresponding to the first-battery assigned amount Assig1 to the second power-supply system in various control ways. For example, assume that the voltage of the second power-supply system PS2 is V2 and the power transmission unit 5 provides an output current I2 denied by Assig1/V2. Hence the output current I2 from the power transmission unit 5 is detected and the duty radio of switching elements to be arranged in the unit 5 is controlled in a feed-back manner so that the detected output current I2 converges at a value of Assig1/V2. In this control, an input power to the power transmission unit 5 is Assig1/η, so that a discharge current from the first battery 2 becomes Assig1/(η·V1), where V1 denotes the voltage of the first power-supply system PS1. This way of control realizes the power transmission described above.

As described so far, the power to be fed to the electric loads during a stop operation of the engine is controlled and its control provides the advantages which will be listed bellow.

First of all, the first battery 2 is given a voltage higher than the second battery 4, resulting in that the resistive loss in the first power-supply system PS1 is reduced to improve fuel consumption. In addition, the generator itself and the cable carrying the power can also be made compact and less weight.

Secondary, under an idling-stop operation of a vehicle, the first battery 2 provides the drive power to the electric lords 3, provided that the residual capacity at the first battery 2 is larger than the predetermined threshold Lev1, even though the first battery 2 is designed to store therein power mainly used for staring the engine. Hence, with no increase in the capacity of the second battery 4, the residual capability of the second battery 4 can be kept for later use, as long as the first battery 2 will allow the power-keeping condition. It is therefore possible to hold, as long as possible, the power transmission to the electric loads 3 during the idling-stop operation.

Third, under an idling-stop operation of a vehicle, immediately after the residual capacity SOH1 of the first battery 2 becomes below the predetermined threshold Lev1, the first and second batteries 2 and 4 both supply power to the same electric loads 3 in cooperation with each other. By this cooperative power supply, burden shares assigned to the first and second batteries 2 and 4 in discharging the power reduces, respectively. Thus both a discharge loss at the second battery 4, which is due to inner resistance in the first battery 2, and a discharge loss due to inner resistance in the second battery 4 can be lessened. Fuel consumption is thus improved thanks to reduced loss in the battery 4 in its discharging operation. The battery 4 can also enjoy its longer lifetime.

A fourth advantage is as follows. In performing the cooperative power supply (cooperatively discharging the power), the discharge current or discharge power from the second battery 4 is made to increase little by little, as the residual capacity SOH1 of the first battery 2 reduces. There are no drastic fluctuations in the power supply voltage to be supplied to the electric loads 3, because the power supply voltages are switched softly to that based on the second battery 4.

A fifth advantage is originated from the order of power transmission processes. In the above embodiment, when an idling-stop operation is started, the first battery 2 disposed to connect with the generator 1 first operates to transmit power to the electronic loads 3 via the power transmission unit 5. Both the first battery 2 and the second battery 4 connected directly to the electric loads 3 then engage in transmitting the electronic loads 3 in a cooperative mariner. Thereafter, the second battery 4 devotes power transmission to the electric loads 3. Accordingly, in cases where a period of idling-stop time is shorter because a traffic signal changes in a short time, the discharge of the second battery 4 can be kept to a small amount or negligible amount of power. In consequence, a drop in voltage to the electronic loads 3 (that is, fluctuations in the power supply voltage), which is on account of the discharge of the second battery 4, can be suppressed well.

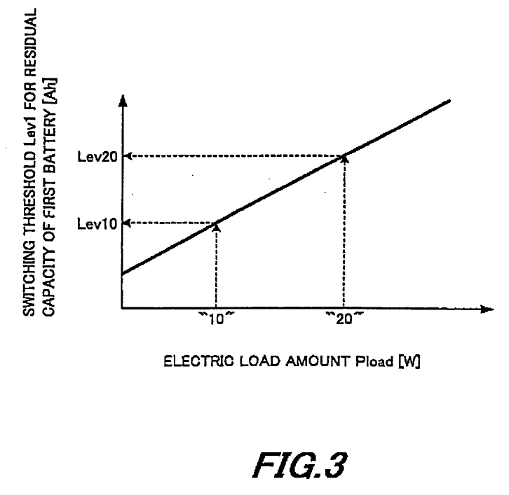

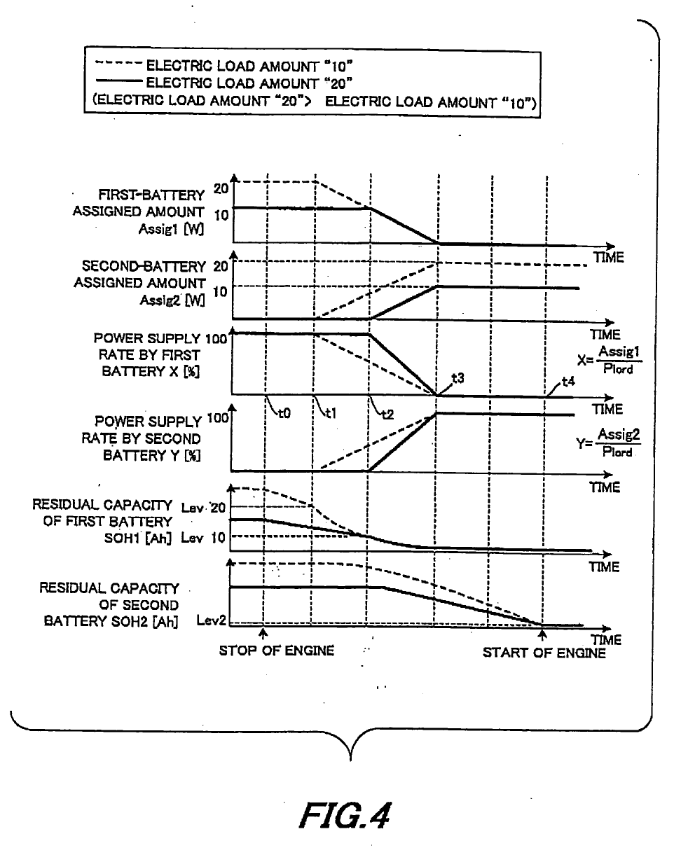

Referring to FIGS. 3 and 4, a modification will now be described, which relates to employing an adjustable switching threshold Lev1.

Though, in the foregoing embodiment, the switching threshold Lev1 has been made constant, this threshold Lev1 may be adjusted depending on an amount of electric loads. This adjustment is shown in FIG. 3.

FIG. 3 shows the relationship between changes in the switching threshold Lev1 and changes in the electric load amount Pload. The switching threshold Lev1 is set to increase linearly with an increase in the electric load amount Pload. In FIG. 3, when the electric load amount Pload is “10” (relative value), the switching threshold Lev1 is Lev10. But the electric load amount Pload=“20” (>“10”) allows the switching threshold Lev1=Lev20 (>Lev10).

A control example that uses the above adjustable switching threshold Lev1 is illustrated in FIG. 4.

As shown therein, if the electric load amount Pload is “20,” that is, the amount Pload is larger, the switching threshold Lev1 is set to a higher level of Lev20 (refer to FIG. 3). As a result, the foregoing processing shown in FIG. 2 makes the first battery 2 supply the electric load amount Pload from a time instant t0 at which an idling-stop starts to a time instant t1 at which the residual capacity SOH1 of the first battery 2 decreases down to the switching threshold Lev1=Lev20. At this time instant t1, both the first and second batteries 2 and 4 start supplying the power cooperatively, during which time of the supply the burden share of the second battery 4 in the discharge grows gradually. That is, the task to supply the power is gradually shifted from the first battery 2 to the second battery 4. At a time instant t3 at which the first-battery assigned amount Assig1 becomes zero, the second battery 4 starts supplying the power corresponding to the electric load amount Pload. This state is also kept for an allowed period of time starting from the time instant t3.

Then, at a time instant t4 when the residual capacity sum “SOH1+SOH2” of the first and second batteries 2 and 4 reduces down to the engine-start threshold Lev2, the engine is commanded to start again, with the idling-stop operation ended.

In cases where the electric load amount Pload is “10,” that is, the amount Pload is smaller, the switching threshold Lev1 is set to a lower level of Lev10 (refer to FIG. 3). As a result, the foregoing processing shown in FIG. 2 makes the first battery 2 supply the electric load amount Pload from a time instant t0 at which an idling-stop starts to a time instant t2 at which the residual capacity SOH1 of the first battery 2 decreases down to the switching threshold Lev1=Lev10. At this time instant t3, both the first and second batteries 2 and 4 start supplying the power cooperatively, is during which time of the supply the burden share of the second battery 4 in the discharge grows gradually. At a time instant t3 at which the first-battery assigned amount Assig1 becomes zero, the second battery 4 starts supplying the power corresponding to the electric load amount Pload. This state is also kept for an allowed period of time starting from the time instant t3.

Then, like the case where the electric load amount Pload is “20,” at a time instant t4 when the residual capacity sum “SOH1+SOH2” of the first and second batteries 2 and 4 reduces down to the engine-start threshold Lev2, the engine is commanded to start again, with the idling-stop operation ended.

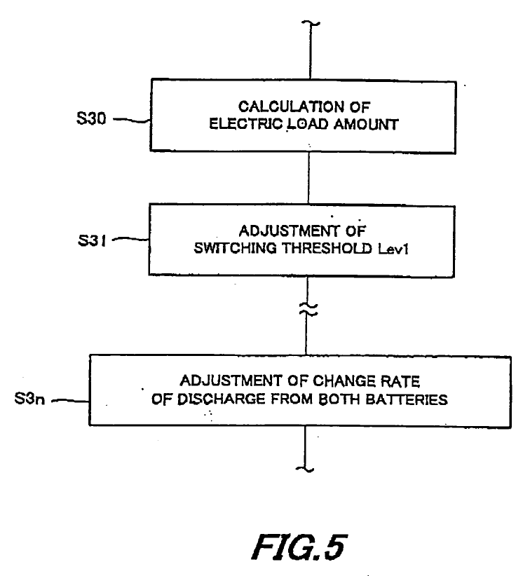

FIG. 5 shows part of the processing performed by the controller 6 at appropriate timings among the processing shown in FIG. 2. The controller 6 calculates the newest electric load amount (step S30), and then changes the switching threshold depending on the newest electric load amount calculated (step S31). In addition, the controller 6 controls the power transmission unit 5 to adjust the discharge rates of discharge from both the batteries at approximately mutual equal values (step S3n) when the cooperative power supply begins.

In this way, when the electric load amount is larger (its impedance is larger) to require a larger amount of current passing the electric loads, the discharge for supplying the power is switched to the cooperative discharge of the first and second batteries 2 and 4 at an earlier timing. In the meantime, when the electric load amount is smaller (its impedance is smaller) to require a lower amount of current passing the electric loads, the discharge for supplying the power is switched to the cooperative discharge of the first and second batteries 2 and 4 at a more delayed timing. Irregularities in the period necessary for a transition from the first battery 2 to the second battery 4 can be almost controlled, in which the shares of the respective batteries 2 and 4 in the currents to be discharged can be changed to hold an approximately constant current-change rate.

Accordingly, the switching timing (the time instant t3) at which the discharge is totally switched to the sole discharge from the second battery 4 is avoided from fluctuating heavily, even when the electric load amount varies. The discharge can therefore be switched over from the first battery 2 to the second battery 4 in a smooth and stable manner.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. An on-vehicle power supplying apparatus comprising:
a first power-supply system having a generator driven by an on-vehicle engine and a first battery charged by the generator,
a second power-supply system having a second battery connected to an on-vehicle electric load;
a power transmission unit transmitting power from the first power-supply system to the second power-supply system; and
a controller controlling an operation of the power transmission unit to adjust, when the engine is stopped, the power transmitted from the first power-supply system to the second power-supply system in a predetermined order in which the first battery is firstly made to transit the power to the electric load, provided that a residual capacity of the first battery is higher than a predetermined threshold.

2. The apparatus according to claim 1, wherein the controller comprises
first means for calculating the residual capacity of the first battery when the engine is stopped,
second means for determining whether or not the residual capacity of the first battery is higher than the predetermined threshold, and
third means for controlling the operation of the power transmission unit to firstly mace the first battery supply the power to the electric load in response to a stop of the engine, when it is determined that the residual capacity of the first battery is higher than the predetermined threshold, and then to make the second battery supply the power to the electric load, together with the supply of the power by the first battery,

3. The apparatus according to claim 2, wherein the controller comprises
fourth means for controlling the operation of the power transmission unit to make both the first and second batteries supply the power to the electric load cooperatively, when it is determined that the residual capacity of the first battery is not higher than the predetermined threshold.

4. The apparatus according to claim 3, wherein the fourth means control the operation of the power transmission unit to not only increase a burden share of the second battery but also decrease a burden share of the first battery in supplying the power, as the residual capacity of the first buttery decreases.

5. The apparatus according to claim 4, wherein the controller comprises
means for adjusting the predetermined threshold depending on a level of the electric load and
means for controlling a change rate of the power supplied by each of the first and second batteries at an approximately constant level during the cooperative supply of the power.

6. An on-vehicle power supplying apparatus comprising:
a first power-supply system having a generator driven by an on-vehicle engine and a first battery charged by the generator;
a second power-supply system having a second battery connected to an on-vehicle electric load;
a power transmission unit transmitting power from the first power-supply system to the second power-supply system; and
a controller controlling an operation of the power transmission unit to adjust, when the engine is stopped, so that both of the first and second batteries supply the power to the electric load cooperatively.

7. The apparatus according to claim 6, wherein the controller controls the operation of the power transmission unit to not only increase a burden share of the second battery but also decrease a burden share of the first battery in supplying the power, as the residual capacity of the first buttery decreases.

8. The apparatus according to claim 7, wherein the controller comprises
means for adjusting the predetermined threshold depending on a level of the electric load and
means for controlling a change rate of the power supplied by each of the first and second batteries at an approximately constant level during the cooperative supply of the power.

9. The apparatus according to claim 6, wherein the controller comprises
means for determining whether or not a sum of the residual capacity of the first battery and a residual capacity of the second battery is equal to or lower than a further predetermined threshold lower than the predetermined threshold, and
means for so the engine when it is determined if the sum of the residual capacities of both the first and second batteries is equal to or lower than a further predetermined threshold.

10. An on-vehicle power supplying apparatus comprising:
a first battery charged by a generator driven by an on-vehicle engine;
a second battery connected to an on-vehicle electric load; and
a power adjuster adjusting power to be supplied from both of the first and second batteries to the electric load in a predetermined order in which the first battery is firstly made to supply the power to the electric load, provided that a residual capacity of the first battery is higher than a predetermined threshold.

11. The apparatus according to claim 10, wherein the power adjuster comprising
a first member calculating the residual capacity of the first battery when the engine is stopped,
a second member determining whether or not the residual capacity of the first battery is higher than the predetermined threshold, and
a third member firstly ring the first battery supply the power to the electric load in response to a stop of the engine, when it is determined that the residual capacity of the first battery is higher than the predetermined threshold, and then making the second battery supply the power to the electric load, together with the supply of the power by the first battery.

12. The apparatus according to claim 11, wherein the power adjuster comprising
is a fourth member determining whether or not a sum of the residual capacity of the first battery and a residual capacity of the second battery is equal to or lower than a further predetermined threshold lower than the predetermined threshold, and
a fifth member starting the engine when it is determined if the sum of the residual capacities of both the first and second batteries is equal to or lower than a further predetermined threshold.

13. The apparatus according to claim 12, wherein the power adjuster comprises
a sixth member making both the first and second batteries supply the power to the electric load cooperatively, when it is determined that the residual capacity of the first battery is not higher than the predetermined threshold.

14. The apparatus according to claim 13, wherein the sixth member controls the power to not only increase a burden share of the second battery but also decrease a burden share of the first battery in supplying the power, as the residual capacity of the first buttery decreases.

15. The apparatus according to claim 14, wherein the power adjuster comprises
a seventh member adjusting the predetermined threshold depending on a level of the electric load and
an eighth member controlling a change rate of the power supplied by each of the first and second batteries at an approximately constant level during the cooperative supply of the power.

16. A method of controlling an on-vehicle power supplying apparatus comprising a first battery charged by a generator driven by an on-vehicle engine and a second battery connected to an on-vehicle electric is load, comprising steps of:
first determining whether or not a sum of residual capacities of the first and second batteries is higher then a predetermined engine-start threshold, when the engine is stopped;
stating the engine when the first determining step determines that the sum of the residual capacities is not higher than the engine-start threshold;
second determining whether or not the residual capacity of the first battery is higher than a predetermined switching threshold, when the first determining step determines that the sum of the residual capacities is higher than the engine-start threshold; and
making the first battery firstly supply the power to the electric load, when the second determining step determines that the residual capacity of the first battery is higher than the predetermined switching threshold.

17. The method according to claim 16, comprising steps of:
making the second battery supply the power to the electric load, together with the supply of the power by the first battery, when the second determining step determines that the residual capacity of the first battery is not higher than the predetermined switching threshold.
